(19) United States
(12) Patent Application Publication
(10) Pub. No.: US 2012/0265781 A1
(43) Pub. Date: Oct. 18, 2012

(54) SEMANTICS-BASED INFORMATION INPUT

(75) Inventors: Yi H. Fan, Beijing (CN); Ying C. Guo, Beijing (CN); Biao Han, Beijing (CN); Sheng B. Hou, Beijing (CN)

(73) Assignee: INTERNATIONAL BUSINESS MACHINES CORPORATION, Armonk, NY (US)

(21) Appl. No.: 13/420,812

(22) Filed: Mar. 15, 2012

(30) Foreign Application Priority Data
Apr. 12, 2011 (CN) 2011100906794

(51) Int. Cl. G06F 17/30

(52) U.S. Cl. 707/769; 707/E17.014

(57) ABSTRACT

A method for semantic-based information input that includes receiving a user input from a user. The method also includes querying a database using the user input as a keyword, wherein the database includes objects, wherein each object includes a name and at least one attribute and ones of the objects include respective pointers to others of the objects indicating types of relationships therebetween. The method further includes receiving a query result, wherein the query result includes at least one matching object for which the keyword matches the at least one object's name or at least one attribute and at least one object with which the at least one matching object has a relationship indicated by the at least one matching object's pointer and presenting the query result to the user.

### CROSS-REFERENCE TO RELATED APPLICATIONS

This application claims priority to Chinese Patent Application No.: 2011100906794, filed Apr. 12, 2011 and all the benefits accruing therefrom under 35 U.S.C. § 119, the contents of which in its entirety are herein incorporated by reference.

### BACKGROUND

The present disclosure relates to the field of information input, and more particularly, to performing semantics-based information input.

Interoperability is a common requirement in industry solutions. Interoperability refers to the ability for information to be shared between different systems. Semantic interoperability is a type of interoperability, and refers to the ability for information transmitted by one system to be correctly interpreted by another system.

In order to achieve semantic interoperability, code systems are currently used in industry solutions. A code system is a system for defining semantic concepts, which defines code, display names, aliases, descriptions and the relationships with other concepts, and so forth. The use of a code system and semantic concepts enable different systems to mutually understand information, so as to obtain semantic interoperability. For example, Systematized Nomenclature of Medicine-Clinical Terms (SNOMED-CT™) is a code system that is used in the medical field and the Construction Classification System (Omniclass™) is a code system used in the construction industry.

Some existing input boxes and input methods only allow an end user to input plain text which does not contain semantic information. For example, in the medical field, a description of an illness input by a doctor into a system may be: “self-reported headache, three days of fever.” This description does not contain semantic information that can be understood by a machine, and does not have interoperability altogether.

Currently, there are generally two alternatives, one of which is to use a pre-defined form. Through a form control, e.g., a drop-down box, selection options are provided to a user. Each option corresponds to a semantic concept in the system. However, this alternative is not user-friendly and with poor usability in that apart from the options, the user is unable to input other information. Moreover, for each form, a corresponding control needs to be developed, which increases a user interface developer's workload.

Another alternative is to allow a user to input information freely, whereupon the information input by the user is automatically transformed by a computer system into contents containing semantic information. That is, through some algorithm, semantic concepts are automatically extracted. The drawback of this alternative is inaccuracy, since the system cannot guarantee the accuracy of the transformed semantic information. More complex algorithms may improve the accuracy, but also increase the workload of developing and debugging.

### SUMMARY

According to an embodiment of the present disclosure, a method for semantic-based information input includes receiving a user input from a user. The method also includes querying a database using the user input as a keyword, wherein the database includes objects, wherein each object includes a name and at least one attribute and ones of the objects include respective pointers to others of the objects indicating types of relationships therebetween. The method further includes receiving a query result, wherein the query result includes at least one matching object for which the keyword matches the at least one object's name or at least one attribute and at least one object with which the at least one matching object has a relationship indicated by the at least one matching object's pointer and presenting the query result to the user.

According to another embodiment of the present disclosure, a system for semantic-based information input includes a user input module configured to receive a user input. The system also includes a user input module configured to receive a user input and a query module configured to use the user input as a keyword to query a database, wherein the database includes objects, wherein each object includes a name and at least one attribute and ones of the objects include respective pointers to others of the objects indicating types of relationships therebetween. The system also includes a result receiving module configured to receive a query result, wherein the query result includes at least one matching object for which the keyword matches the at least one object's name or at least one attribute and at least one object with which the at least one matching object has a relationship indicated by the at least one matching object's pointer and a presenting module configured to present the query result to the user.

A further embodiment is a computer program product for semantic-based information input. The computer program product includes a computer readable storage medium having computer readable program code embedded therewith, the computer readable program code includes computer readable program code configured for performing a method. The method inludes includes receiving a user input from a user. The method also includes querying a database using the user input as a keyword, wherein the database includes objects, wherein each object includes a name and at least one attribute and ones of the objects include respective pointers to others of the objects indicating types of relationships therebetween. The method further includes receiving a query result, wherein the query result includes at least one matching object for which the keyword matches the at least one object's name or at least one attribute and at least one object with which the at least one matching object has a relationship indicated by the at least one matching object's pointer and presenting the query result to the user.

### BRIEF DESCRIPTIONS OF THE ACCOMPANYING DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram illustrating one example of a computing system for practice of the teachings herein;

FIG. 2 is a flowchart of method for semantics-based information input in accordance with an exemplary embodiment of the present disclosure;

FIG. 3 is a block diagram illustrating an exemplary semantic database including objects and the relationships between the objects; and

FIG. 4 is a block diagram of system for semantics-based information input in accordance with an exemplary embodiment of the present disclosure.

### DETAILED DESCRIPTION

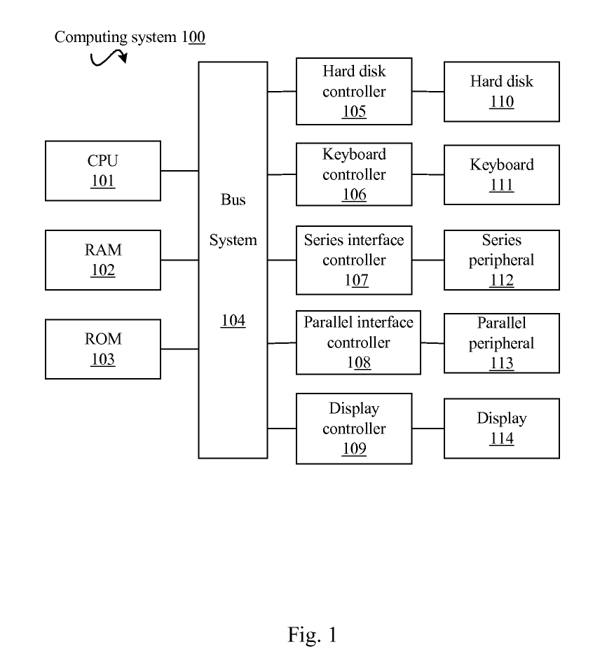

Referring now to FIG. 1, a block diagram of an exemplary computing system 100 adapted to practice of the teachings herein is illustrated. As shown, the computer system 100 may include a CPU (central processing unit) 101, RAM (random access memory) 102, ROM (read only memory) 103, a system bus 104, a hard disk controller 105, a keyboard controller 106, a series interface controller 107, a parallel interface controller 108, a display controller 109, a hard disk 110, a keyboard 111, a serial peripheral 112, a parallel peripheral 113 and a display 114. Among these devices, the CPU 101, RAM 102, ROM 103, the hard disk controller 105, the keyboard controller 106, the serial controller 107, the parallel controller 108 and the display controller 109 are coupled to the system bus 104. The hard disk 110 is coupled to the hard disk controller 105, the keyboard 111 is coupled to the keyboard controller 106, the serial peripheral 112 is coupled to the serial interface controller 107, the parallel peripheral 113 is coupled to the parallel interface controller 108, and the display 114 is coupled to the display controller 109. It will be understood by those of ordinary skill in the art that the system shown in FIG. 1 is only for illustration purpose, rather than limitation to the scope of the present invention.

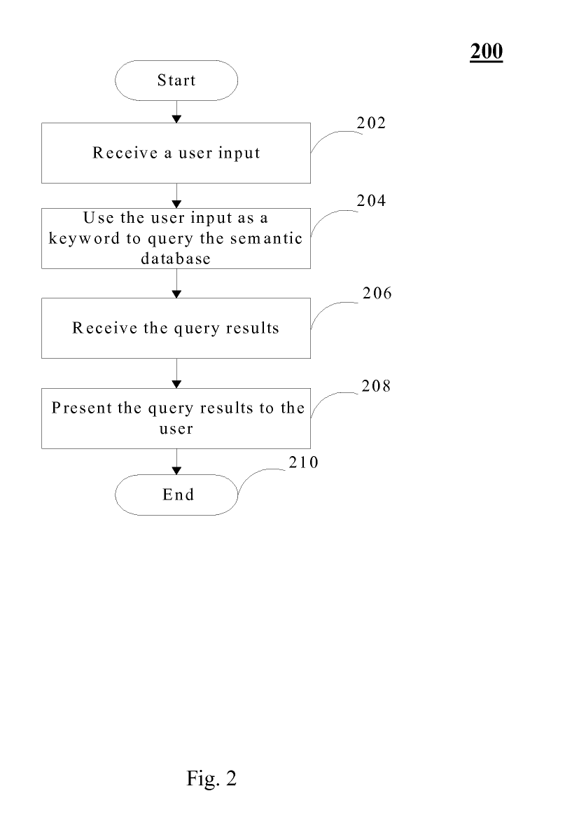

Turning now to FIG. 2, a flowchart illustrating a method 200 for semantics-based information input according to an exemplary embodiment of the present disclosure is shown. As shown at block 202, the method 200 includes receiving an initial user input. In exemplary embodiments the user input can be a text, or numeric code. In addition, the user may perform the information input through a variety of information input methods including, but not limited to, use of a keyboard, a mouse, voice recognition software, or the like. Next, as shown at block 204, the initial user input is used as a keyword to query a semantic database. In exemplary embodiments, the sematic database is an object-based database. The query results are then received from the semantic database, as shown at block 206. In exemplary embodiments, the results obtained by using the user input to query the semantic database are object-based. Accordingly, the query results received by the user are also object-based. Once the results have been received, the results are presented to the user, as shown at block 208. In exemplary embodiments, presenting the query results to the user includes presenting the object names of the objects to the user. In exemplary embodiments, in addition to the object names of the objects, the attributes of the objects may also be presented to the user.

In exemplary embodiments, the semantic database may be an object-based database. A semantic database organizes and stores data by objects and the relational structure between the objects. It can be a traditional relational database, or any other system which can build and store relationships among objects. Common examples of semantic databases are SNOMED-CT™ and Omniclass™.

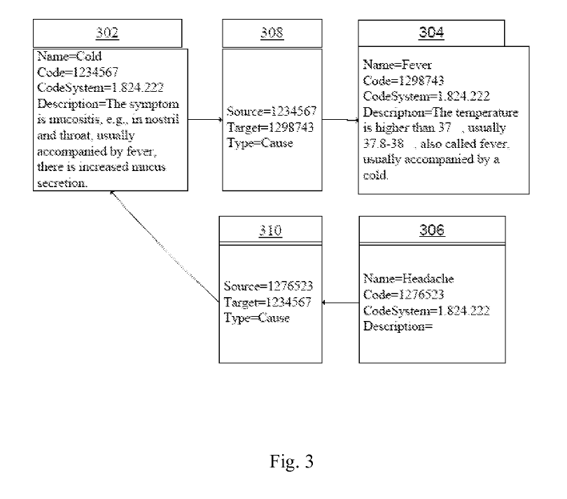

Referring to FIG. 3, a block diagram illustrating an exemplary semantic database including objects and their relationships is shown. The semantic database includes object 302, object 304, object 306, relationship 308 and relationship 310. Each of the objects 302, 304, 306 includes various attributes such as object name, object code, code system to which the objects belong CodeSystem and object description. In the illustrated instance, relationship 308 between object 302 and object 304 has a type “Cause,” which indicates that there is a causal relationship between object 302 and object 304. Likewise, relationship 310 between object 306 and object 302 also has a type “Cause,” which indicates that there is a causal relationship between object 306 and object 302.

It should be appreciated that FIG. 3 is only an exemplary illustration, and those skilled in the art know that besides the objects, the attributes of the objects and the relationships between the objects exemplarily illustrated in FIG. 3, there may be other objects, attributes of the objects and relationships between the objects. Moreover, in different semantic databases, the objects, attributes of the objects and the relationships between the objects may be in different forms. Those skilled in the art know that the specific semantic database that needs to be queried will be determined according to requirements; and no matter which kind of semantic database is selected, the implementation of the technical solutions in the present disclosure will not be affected.

According to an embodiment of the present disclosure, after the initial user input is received, the user input is used as a keyword to query the semantic database. The process of querying performs a process of keyword matching. For example, taking “Cold” as the user input “Cold” is used as the keyword to execute keyword matching in the sematic database. According to an embodiment of the preset disclosure, through the process of using “Cold” as the keyword to perform keyword matching in the sematic database, the objects including the keyword of “Cold” in the object names or object attributes are returned as the query results satisfying the condition. Taking FIG. 3 as an example, since the object name of object 302 is “Cold,” object 302 is returned as a query result satisfying the condition. Since the attributes of object 304 have “Cold” (in the attribute “object description” of object 304), object 304 is also returned as a query result satisfying the condition.

Thus, as described above, objects include the keyword “Cold” in their object names or object attributes (e.g., object 302 and object 304) may be returned as keyword query results satisfying a condition indicated by an initial user-input. Further, according to an exemplary embodiment, other objects connected with the query results may also be included in the returned query results satisfying the initial user-input condition. These additional query results arise by satisfying the initial user-input condition via relationships between the objects of the initial query results. For example, objects 304 and 306 may be returned as additional query results due to being connected with object 302 via “Cause” relationships.

A user input is used as a keyword to construct a query statement, such as a SQL query statement. As described, the results obtained by querying the semantic database using the initial user input as the keyword are object-based. The process of querying the semantic database may include executing the query statement in the semantic database so as to obtain the query results.

In exemplary embodiments, once the names of the objects are presented to the user, the user is able to select one of the objects presented. After the user selects one of the objects, the attributes of the object are presented to the user. For example, assuming that the user input is “Cold”, the semantic database is queried by using “Cold” as the keyword to obtain the object-based query results. As a result, the object names of the objects, i.e., “Cold,” “Fever” and “Headache,” are presented to the user. In response to the user selecting a name of an object presented, the attributes of the object are further presented to the user. For example, when the user selects the object name “Cold” of the object 302, the attributes of object 302 will be displayed as follows:
object name: Cold
object code: 1234567:
code system to which it belongs: 1.824.222
object description: The symptom is mucus it is, e.g., in nostril and throat, usually accompanied by fever, there is increased mucus secretion.

In exemplary embodiments, the relationships between a selected object and other objects may also be presented to the user when the user selects a query result object. For example, if the user selects the object name of object 302, which is “Cold,” the relationships between object 302 and other objects are presented to the user, that is, the relationship (“Cause”) between object 302 and object 304 and the relationship (“Cause”) between object 306 and object 302.

In exemplary embodiments, once a user is presented with query results (e.g., object name) that arose from the user's initial input, the user can select one of the query results as a next user input, referred to herein as a “determined” user input. For example, if the user selects object 302 from among the query results, then object 302 is taken as the determined user input, and according to an embodiment, a corresponding query result is output based on the selected object.

In exemplary embodiments, the object-based query result includes information like an object name, other attributes of the object and the relationship between objects. Therefore, users can obtain semantic information corresponding to a text while inputting the text. Since the text input by the user is accurate, the semantic information determined by the accurate text is also accurate. Thus, it solves the traditional problem that is presented when the user inputs information freely and the system is unable to guarantee the accuracy of the transformed semantic information. Also, applying the method and system provided by the present disclosure does not need to increase the user interface developers' workload. Since there is accurate semantic information corresponding to the accurate text, semantic interoperability is also greatly improved.

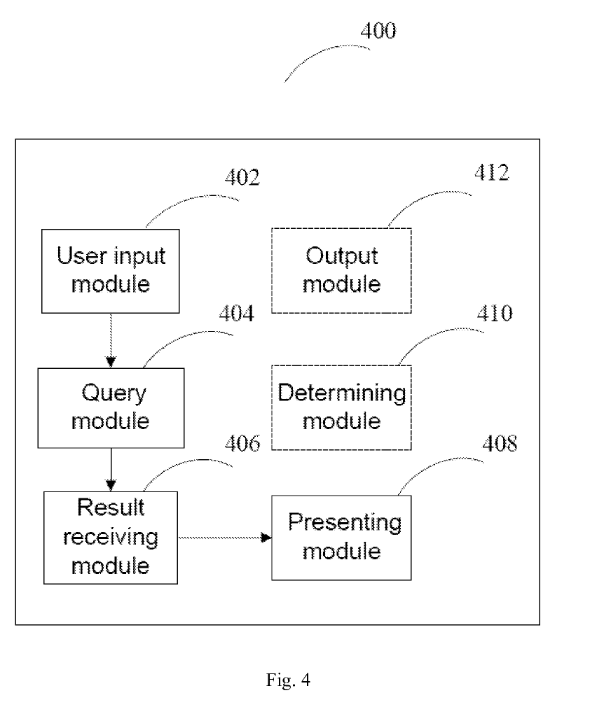

Referring now to FIG. 4, a block diagram of system 400 for semantics-based information input in accordance with an exemplary embodiment of the present disclosure is shown. The system 400 includes a user inputting module 402 configured to receive a user input and a query module 404 configured to use the user input as a keyword to query a semantic database. In exemplary embodiments, the semantic database is object-based database. The system 400 also includes a result receiving module 406 configured to receive the query results and a presenting module 408 configured to present the query results to the user.

In exemplary embodiments, the user input module 402 receives a user input, which may be in the form of text, or numeric code. In response to receiving the user input, the query module 404 uses the user input as a keyword to query the semantic database. The query module takes the objects containing the keyword in the object names or the object attributes as query results satisfying the condition. In exemplary embodiments, in addition to the objects that contain the keyword in their object names or object attributes being taken as query results satisfying the condition, other objects connected with the query results satisfying the condition through relationships between objects may also be returned as query results satisfying the condition. Next, the result receiving module 406 receives the object-based query results and the presenting module 408 presents the query results to the user. The query results may include the object names and attributes of the objects, and may also include the relationships between the objects.

In exemplary embodiments, the presenting module 408 is configured to present the object names of the objects in the query results to the user. In addition, the presenting module 408 may be further configured to present the attributes of the object and the relationships between the objects to the user in response to the user selecting an object name of the objects in the query results. The system 400 may also include a determining module 410 configured to use the selected query result as a determined user input in response to that a presented query result is selected. In addition, the system 400 can include an output module 412 configured to output the selected query result based on the determined user input or selected object.

Above the basic principles of the present disclosure have been described in conjunction with the specific embodiments. However, it should be pointed out that to those of ordinary skill in the art, all or any steps or components of the method and apparatus of the present disclosure can be realized in hardware, software or a combination thereof in any computing device (including processors and storage mediums etc.) or networks of computing devices, and can be realized by those of ordinary skill in the art using their basic programming skills after reading the specification of the present disclosure.

Therefore, the objective of the present disclosure can further be realized by running one or a group of programs on any computing device. The computing device can be any known general-purpose device. Therefore, the objective of the present disclosure can also be realized by merely providing a program product containing the program code for realizing the method or the apparatus. That is to say, such a program product also forms the present disclosure, and a storage medium storing such a program product also forms the present disclosure. The storage medium can be any well-known storage medium or any storage medium that will be developed in the future.

It should be further pointed out that in the apparatus and method of the present disclosure, the components or steps can be split and/or recombined. Such splitting and/or recombination should be viewed as equivalent solutions of the present disclosure. Moreover, the steps executing the above series of processing may naturally be executed in the time order according to the described sequence, but are not necessary to be executed in the time order. Some steps may be executed in parallel or independent of each other.

Although the present disclosure and its advantages are described in detail, it should be understood that various changes, replacements and transformation can be made without departing from the spirits and scope of the present disclosure as defined by the appended claims. Moreover, the terms “comprise”, “include” or any other variants in the present application are intended to cover non-exclusive inclusion, so that the processes, methods, articles or devices including a series of elements not only include these elements, but also include other elements not explicitly listed, or include elements inherent to such processes, methods, articles or devices. When there are no more restrictions, an element defined by the phrase “comprising a . . . ” does not exclude the existence of other identical elements in the processes, methods, articles or devices including the element.

1. A method for semantic-based information input, comprising:
receiving a user input from a user;
querying a database using the user input as a keyword, wherein the database includes objects, wherein each object includes a name and at least one attribute and ones of the objects include respective pointers to others of the objects indicating types of relationships therebetween;
receiving a query result, wherein the query result includes at least one matching object for which the keyword matches the at least one object's name or at least one attribute and at least one object with which the at least one matching object has a relationship indicated by the at least one matching object's pointer; and
presenting the query result to the user.

2. The method of claim 1, wherein the user input includes text or numeric code.

3. The method of claim 1, wherein the query result includes object names and attributes of the query result objects.

4. The method of claim 1, wherein the query result further includes presenting the at least one relationship between the at least one matching object and the at least one object with which the at least one matching object has a relationship.

5. The method of claim 3, wherein presenting the query result to the user comprises presenting the object names of the query result objects.

6. The method of claim 3, further comprising presenting to the user the one or more attributes of a selected object to the user in response to the user selecting the selected object from the query results.

7. The method of claim 5, wherein presenting the query result to the user further comprises presenting to the user the at least one relationship between the at least one matching object and the at least one object with which the at least one matching object has a relationship.

8. The method of claim 1, further comprising:
querying the database using a selected query result as a determined user input.

9. The method of claim 8, further comprising outputting the determined user input.

10. A system for semantic-based information input, comprising:
a user input module configured to receive a user input;
a query module configured to use the user input as a keyword to query a database, wherein the database includes objects, wherein each object includes a name and at least one attribute and ones of the objects include respective pointers to others of the objects indicating types of relationships therebetween;
a result receiving module configured to receive a query result, wherein the query result includes at least one matching object for which the keyword matches the at least one object's name or at least one attribute and at least one object with which the at least one matching object has a relationship indicated by the at least one matching object's pointer; and
a presenting module configured to present the query result to the user.

11. The system of claim 10, wherein the user input includes text or numerical code.

12. The system of claim 10, wherein the query result includes object names and attributes of the query result objects.

13. The system of claim 10, wherein the query result further includes presenting the at least one relationship between the at least one matching object and the at least one object with which the at least one matching object has a relationship.

14. The system of claim 12, wherein the presenting module is further configured that, presenting the query results to the user comprises presenting the object names of the query results object.

15. The system of claim 14, wherein the presenting module is further configured to present to the user attributes of the object to the user in response to the user selecting the selected object from the query results.

16. The system of claim 14, wherein the presenting module is further configured to present to the user the at least one relationship between the at least one matching object and the at least one object with which the at least one matching object has a relationship.

17. The system of claim 10, further comprising a determining module configured to use the selected query result as a determined user input.

18. The system of claim 17, further comprising an output module configured to output the determined user input.

19. A computer program product for semantic-based information input, the computer program product comprising:
a computer readable storage medium having computer readable program code embedded therewith, the computer readable program code comprising:
computer readable program code configured for performing a method comprising:
receiving a user input from a user;
querying a database using the user input as a keyword, wherein the database includes objects, wherein each object includes a name and at least one attribute and ones of the objects include respective pointers to others of the objects indicating types of relationships therebetween;
receiving a query result, wherein the query result includes at least one matching object for which the keyword matches the at least one object's name or at least one attribute and at least one object with which the at least one matching object has a relationship indicated by the at least one matching object's pointer; and
presenting the query result to the user.

20. The computer program product of claim 19, wherein the user input includes text or numeric code.
